(19) United States
(12) Patent Application Publication
(10) Pub. No.: US 2003/0077355 A1
(43) Pub. Date: Apr. 24, 2003

(54) Closing unit for a plastic molding machine

(75) Inventor: Erwin Laar, Holzkirchen (DE)

Correspondence Address: HENRY M FEIEREISEN, 350 FIFTH AVENUE, SUITE 3220, NEW YORK, NY, 10118, US

(73) Assignee: KRAUSS-MAFFEI KUNSTSTOFFTECHNIK GMBH, Munchen (DE)

(21) Appl. No.: 10/278,307

(22) Filed: Oct. 23, 2002

(30) Foreign Application Priority Data
Oct. 24, 2001 (DE) 101 52 392.0

(51) Int. Cl. B29C 45/66

(52) U.S. Cl. 425/592; 425/595; 425/451.5; 425/451.9

(57) ABSTRACT

A closing unit for plastic molding machine includes a lower mold mounting plate, and an upper mold mounting plate, which are moveable via a pivot bearing between an open position and a closed position and can be locked in the closed position by a locking mechanism. The upper mold mounting plate is pivotable by a crank drive relative to the lower mold mounting plate, whereby the closed position is suitably commensurate with a dead center position of the crank drive. The lower mold mounting plate may be swingably mounted and includes locking members to secure the lower mold mounting plate in at least one pivot position. Further locking members are provided to secure the upper mold mounting plate in the open position.

### CROSS-REFERENCES TO RELATED APPLICATIONS

This application claims the priority of German Patent Application, Serial No. 101 52 392.0, filed Oct. 24, 2001, pursuant to 35 U.S.C. 119(a)-(d), the disclosure of which is incorporated herein by reference.

### BACKGROUND OF THE INVENTION

The present invention relates, in general, to a closing unit of a plastic molding machine of a type having upper and lower mold mounting pates and a drive unit for moving the mold mounting plates relative to one another between an open position and a closed position.

Mold mounting plates (or mold carriers) are provided to support the mold tools which demarcate a cavity, when closed, to produce a molded plastic article. Hereby, for example, a reactive plastic mixture is introduced into the cavity and allowed to react. The drive unit for opening and closing the closing units is constructed in the form of hydraulic drives, ball screws or pneumatic drives. Hydraulic drives are relatively complex and entail a risk of contamination as a result of leaking hydraulic fluid, while ball screws are rather limited in their application as far a rotation speed and thus velocity of executed motions are concerned. Pneumatic drives experience problems as far as starting phase, load changes, or braking phase at higher speeds are concerned.

It would therefore be desirable and advantageous to provide an improved closing unit for a molding machine, which obviates prior art shortcomings and which allows rapid opening and closing at short cycle times in a simple manner while still being reliable in operation.

### SUMMARY OF THE INVENTION

According to one aspect of the present invention, a closing unit for a plastic molding machine, includes first and second mold mounting plates, and a crank drive for realizing a relative movement of the first and second mold mounting plates between opening and closed positions. Suitably, the closed position is hereby established, when the crank drive assumes a dead center disposition.

The present invention resolves prior art problems by configuring the drive unit for the closing unit in the form of a crank drive. In the end positions, i.e. dead center position, the crank drive applies high forces at slight speed or at a speed of zero. Acceleration or delay of the mold mounting plate is realized by the mechanical construction so that the need for complex controls or ramps is no longer required. As a consequence, the motor, used for operating the crank drive, can start to run at the beginning of a cycle at no load or only at slight load whereas a stopping in the end position requires only a braking of the own flywheel moment. As a consequence of the dead center position in the closed position, a precise positioning of the crank is not necessary and a possible after-running is uncritical.

According to another feature of the present invention, the closing unit occupies the open position, when the crank drive assumes a further dead center position. Since the moving mold carrier has to be stopped also in the open position of the mold, the advantages of the dead center position can be exploited also for this situation.

According to another feature of the present invention, the crank drive may be simply realized by a drive train which may be composed of a driven crank arm and a lever which are hingedly connected together, whereby one end of the drive train is connected to one mold mounting plate and another end is connected to the other mold mounting plate or a support that is mounted on a base frame structure. Attachment of the drive train to a support is advantageous because a single drive can be used for commonly pivoting both mold mounting plates. Suitably, detachable locking members are provided to hold the mold carriers in the closed position or open position, whereby one mold carrier is swingably mounted on a base frame structure and can be held in place in at least one pivoted position.

According to another feature of the present invention, there are provided releasable pivot bearings arranged on opposite sides of the mold mounting plates. Suitably, the drive train engages at midpoint between the pivot bearings. When releasing in this configuration one of the pivot bearings, the mold can be opened to this side, while the other pivot bearing serves as rotation point. In this way, it is, for example, possible to introduce material from one side into the opened mold and to remove the finished molded plastic article from the other side.

In the event, the closing unit has a fixed pivot bearing, the drive train suitably engages laterally of the pivot bearing on the side of the mold carrier, facing away from the opening of the closing unit. In this way, the opening of the closing unit becomes accessible from three sides.

Depending on the size of the closing unit, it may be sufficient to provide only one crank drive. However, the present invention contemplates also the provision of a plurality of crank drives.

A crank drive according to the present invention is suitable for use in particular in connection with reaction molding machines.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view of a first embodiment of a closing unit according to the present invention in a closed position;

FIGS. 2a-2e are schematic side views of the closing unit in various operating positions during a production process,

FIGS. 3a-3e are schematic side views of a second embodiment of a closing unit according to the present invention in various operating positions during a production process;

FIGS. 4a-4e are schematic side views of a third embodiment of a closing unit according to the present invention in various operating positions during a production process;

FIGS. 5a-5f are schematic side views of a fourth embodiment of a closing unit according to the present invention in various operating positions during a production process;

FIGS. 6a-6e are schematic side views of a fifth embodiment of a closing unit according to the present invention in various operating positions during a production process; and

FIGS. 7a-7e are schematic side views of a sixth embodiment of a closing unit according to the present invention in various operating positions during a production process.

### DETAILED DESCRIPTION OF PREFERRED EMBODIMENTS

Throughout all the Figures, same or corresponding elements are generally indicated by same reference numerals.

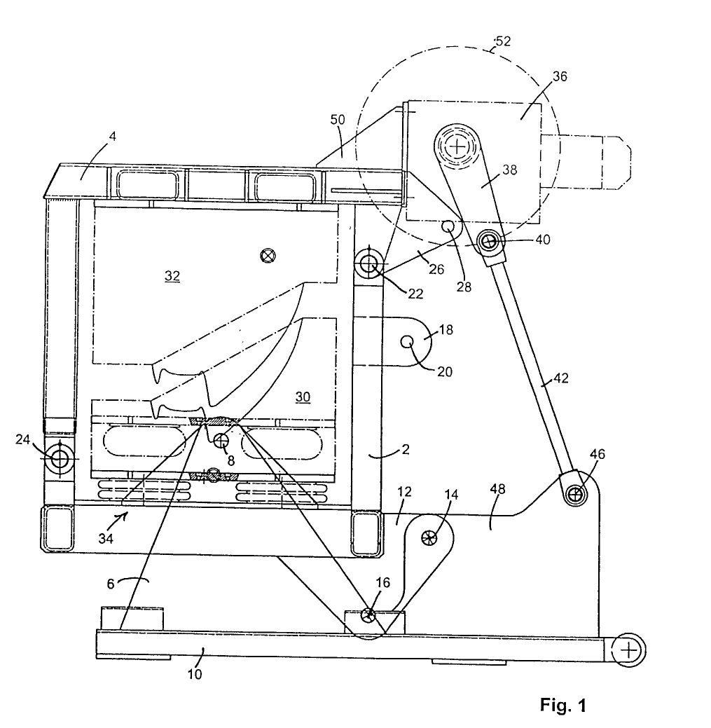

Turning now to the drawing, and in particular to FIG. 1, there is shown a schematic side view of a first embodiment of a closing unit according to the present invention of a reaction molding machine and supported on a machine bed 10. The closing unit includes a lower mold carrier 2 and an upper mold carrier 4. To ensure clarity, it is to be understood that the term “mold carrier” and “mold mounting plate” will be used throughout this disclosure interchangeably.

The lower mold carrier 2 is swingably mounted on a laterally disposed main support 6 via a pivot bearing 8 for rotation with respect to the machine bed 10. For convenience and sake of simplicity, much of the following description is made only in relation to one side of the closing unit, when in fact the two sides of the closing unit are mirror images of one another about an imaginary vertical medial plane which bisects the left from the right of the closing unit. Thus, although the main support 6 and the pivot bearing 8 will be described with respect to only one side of the closing unit, it will be understood that the same components of the closing unit are duplicated on the opposite (not visible) side of the closing unit.

Mounted to the lower right end of the mold carrier 2 is a locking bracket 12 of substantially triangular configuration with two locking openings 14, 16. A further locking bracket 18 with a locking opening 20 is provided above the locking bracket 12 on a side of the mold carrier 2. The upper mold carrier 4 is connected to the lower mold carrier 2 via a pivot bearing 22 and a releasable locking mechanism 24. A locking bracket 26 is mounted on the right side of the upper mold carrier 4 and provided with a locking opening 28.

When closed, the mold carriers 2, 4 define a substantially block-shaped structure and support interiorly respective half-molds 30, 32 which define a cavity for formation of a plastic article, when fully closed. As further shown in FIG. 1, the closing unit includes a shifting device, generally designated by reference numeral 34, for moving the lower half-mold 30 in parallel relationship to the lower mold carrier 2 for closing the cavity. A motor 36 is secured to the topside of the mold carrier 4 via an attachment member 50 to operate a crank drive comprised of a crank arm 38 and a lever 42 which are articulated to one another by a joint 40. The lever 42 is swingably mounted in a pivot bearing 46 which is provided in a support 48 that is securely fixed to the machine bed 10. The crank arm 38 and the lever 42 define a drive train which in the non-limiting example of FIG. 1, is situated to the side of the mold carrier 2. Thus, if need be, a second such drive train may be provided at the opposite (not visible in FIG. 1) side of the mold carrier 2.

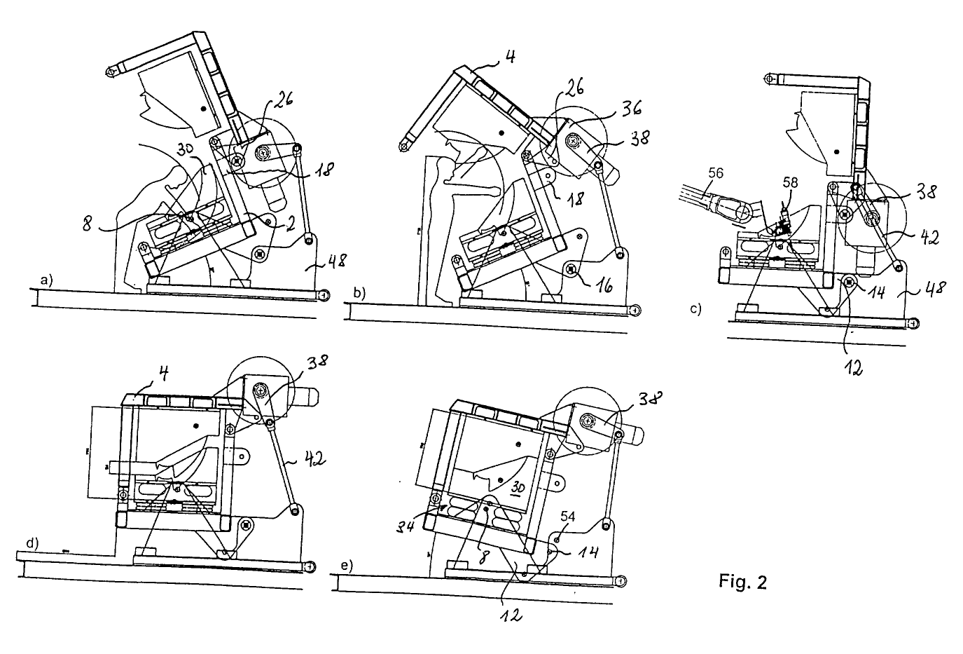

The mode of operation of the closing unit of FIG. 1 will now be described in more detail with reference to FIGS. 2a to 2e. For convenience and ease of illustration, FIGS. 2a to 2e include only those reference numerals that are relevant for the understanding of the present invention.

Starting point for a production cycle is the position of the closing unit as illustrated in FIG. 2a. In this position, the closing unit is fully opened and inclined to the left about the pivot axis of the pivot bearing 8 to thereby allow an operator to place a skin into the lower half-mold 30 for production of a finished plastic article. The lower mold carrier 2 is locked in place in this position via the locking opening 16 and a respective locking opening 54 (shown in FIG. 2e) of the support 48. Optionally, the closing unit can be further shifted into the position, shown in FIG. 2b to permit placement of further inserts in the upper mold carrier 4, or placement of a further skin, or for cleaning of the upper half-mold 32, whereby the locked relationship between the brackets 26 and 18 is released and the upper mold carrier 4 is lowered in clockwise through turning of the crank arm 38.

Subsequently, the upper mold carrier 4 is returned to the position of FIG. 2a and the brackets 18, 26 are locked together again. The locking opening 16 is released and the crank arm 38 is moved counterclockwise by the motor 36 until the drive train reaches a dead center position in which the crank arm 38 and the lever 42 are aligned in overlapping relationship, as shown in FIG. 2c. In this position, the locking opening 14 of the lower mold carrier 2 is aligned with the locking opening 54 of the support 48 to enable a locked engagement of the bracket 12 and the support 48. Subsequently, reactive foam material is then supplied via feed lines 56 and a mixing head 58 to the lower half-mold 30. The locked engagement between the lower and upper mold carriers 2, 4 is released and the upper mold carrier 2 is lowered by turning the crank arm 38 until the drive train reaches the second dead center position in which the crank arm 38 and the lever 42 are aligned in non-overlapping relationship, i.e. the crank arm 38 extends in prolongation of the lever 42, and the closing unit is closed. This position is shown in FIG. 2d, whereby the locking mechanism 24 is closed to fully clamp the closing unit.

Actuation of the shifting device 34 moves the half-mold 30 until the cavity of the half-molds 30, 32 is closed. This situation is shown in FIG. 2e, whereby the mold may be, optionally, adjusted to assume a reaction position in which the closed closing unit is inclined to the right through rotation about the pivot axis of pivot bearing 8. Hereby, the locked engagement of the locking opening 14 in the bracket 12 is released, and the crank arm 38 rotates counterclockwise. The reaction position is normally selected to enable a discharge of gases, which develop during the reaction, from the cavity. Of course, the reaction position may be modified during the reaction, if need be.

After conclusion of the reaction, the closing unit is returned to the upright position and locked in place, while the locking mechanism 24 is released. The upper mold carrier 4 is moved to the fully open position and locked, whereas the lower mold carrier 2 is released and the open closing unit is pivoted to the position of FIG. 2a. The finished molded plastic article can be removed and the production cycle may be repeated again.

The afore-described locked engagements of the locking openings 14, 16, 54, and 28, 22 can be implemented in a simple manner by pins (not shown) which are insertable when the respective locking openings are aligned. Suitably, locking is executed automatically, whereby the pins can be operated in a known manner electromagnetically, pneumatically, hydraulically or mechanically.

In the exemplified embodiment of the closing unit of FIGS. 1 and 2, the motor 36 is attached to the upper mold carrier 4 laterally of the pivot bearing 22. In this way, the motor 36 provides a counterweight to the remainder of the upper mold carrier 4 so that the motor 36 can be configured for reduced power output. Although, only one crank drive is shown in FIGS. 1 and 2, it is certainly possible to use per closing unit several crank drives which may be operated by a single motor, or each crank drive may be operated by a separate motor.

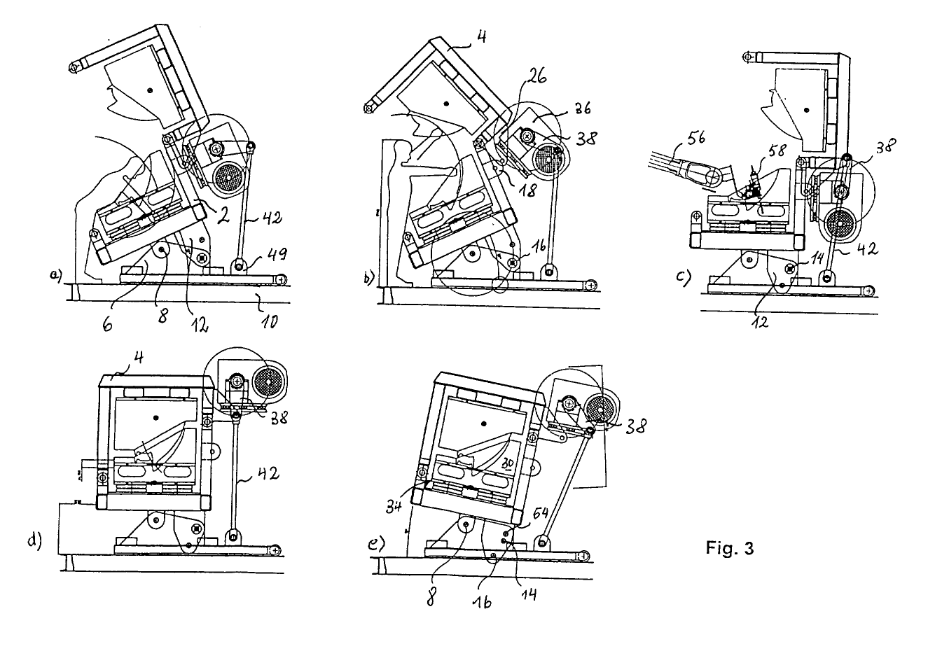

Turning now to FIGS. 3a-3e, there are shown schematic side views of a second embodiment of a closing unit according to the present invention in various operating positions during the production process. Parts corresponding with those in FIGS. 1 to 2 are denoted by identical reference numerals and not explained again. In this embodiment, the pivot bearing 8 on the main support 6 is situated here below the lower mold carrier 2, and the locking bracket 12 is arranged also beneath the lower mold carrier 2 and secured, instead to a support 48, to the main support 6 which also includes the locking opening 54. The lever 42 is swingably mounted via a bracket 49 to the machine bed 10. The production cycle is executed in substantially the same manner as described in conjunction with FIG. 2.

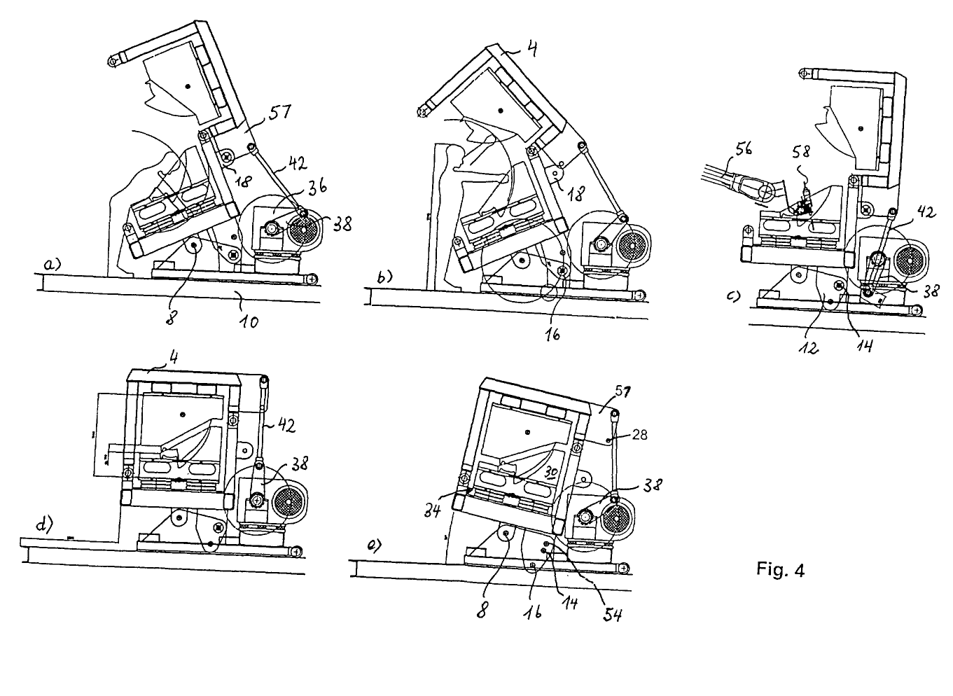

FIGS. 4a-4e show various operating positions during a production process of a third embodiment of a closing unit according to the present invention. Parts corresponding with those in FIGS. 1 to 3 are denoted by identical reference numerals and not explained again. In this embodiment, the motor 36 is connected together with the crank arm 38 to the machine bed 10, whereby the lever 42 is swingably mounted to a bracket 57 (FIG. 4e) which replaces here the bracket 26 of FIGS. 2 and 3 and thus includes the locking opening 28. The closing unit of FIGS. 4a to 4e is thus a kinematic reversal of the mode of operation of the closing units according to FIGS. 2 and 3. The production cycle is executed in substantially the same manner as described in conjunction with FIG. 2.

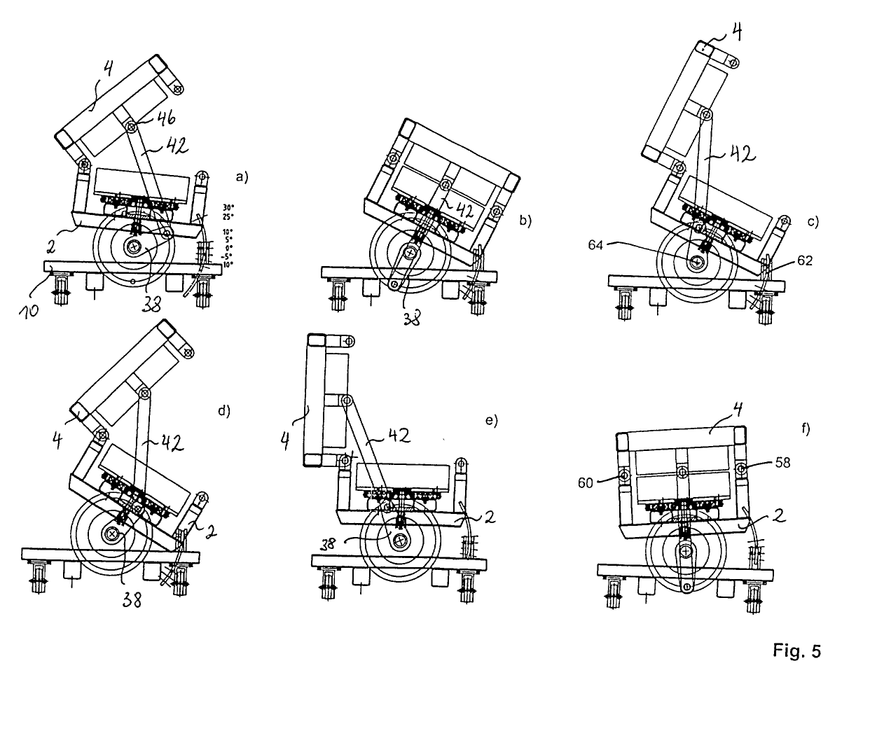

FIGS. 5a-5f show various operating positions during a production process of a fourth embodiment of a closing unit according to the present invention. Parts corresponding with those in FIG. 1 are denoted by identical reference numerals and not explained again. In this embodiment, the pivot axis of the pivot bearing 8 is disposed centrally beneath the mold carrier 2, and the lever 42 is secured approximately at midpoint to the upper mold carrier 4 via pivot bearing 46. Thus, the lower mold carrier 2 swings about the rotation axis 64 (FIG. 5c) of the crank arm 38, whereby the compressed dead center position, in which the lever 42 and the crank arm 38 are in overlapping aligned relationship (FIGS. 5b, 5f), the closed closing unit can be rotated. When the closing unit occupies the other extended dead center position in which the lever 42 and the crank arm 38 are in aligned position in prolongation of one another, the closing unit can be rotated with the half-mold 30, 32 in opened disposition, as shown in FIGS. 5c, 5e). A pivoting of the mold carriers 2, 4 together can be realized by the locked engagement as described in connection with FIG. 2a to 2e.

In the exemplified embodiment of FIG. 5, the mold carriers 2, 4 have each a symmetric configuration and include releasable pivot bearings 58, 60 (FIG. 5f). Release of one of the pivot bearings 58, 60 allows opening of the closing unit to a respective side so that the closing unit is accessible from either side during the production process. Springs 62 (FIG. 5c) are provided for compensating or reducing a movement moment of the closing unit.

FIGS. 5a to 5d show the position of the upper mold carrier 4 during a revolution of the crank drive. FIG. 5a depicts an intermediate open position of the closing unit, in which the upper mold carrier 4 is partially open while the lower mold carrier 4 is slightly inclined to the right. The crank drive can then be operated by the motor (not shown) to move the mold carrier 2 into closed position with the lower mold carrier 4. This position is reached, when the lever 42 and the crank arm 38 are in overlapping aligned relationship (compressed dead center position). The lower mold carrier 2 can swing about the rotation axis 64. The lower mold carrier 2 is locked in place in this position (FIG. 5b) and molding operation may commence. After conclusion of the molding process, the lever 42 is moved until reaching the upper dead center position to fully open the upper mold carrier 4 with respect to the lower mold carrier 2. In this position, which is shown in FIG. 5c, the upper mold carrier 4 extends at an angle of about 90° with respect to the lower mold carrier 2. Through further rotation of the crank arm 38 away from the extended dead center position, the upper mold carrier 4 is moved toward the lower mold carrier 2, as shown in FIG. 5d. This completes one revolution of the crank drive. FIG. 5e depicts again a position in which the crank drive occupies the extended dead center position, with the upper mold carrier 4 fully opened relative to the lower mold carrier 2, whereby the lower mold carrier 2 is now in horizontal disposition. FIG. 5f depicts the fully closed closing unit at slight inclination, whereby the crank drive assumes the compressed dead center position.

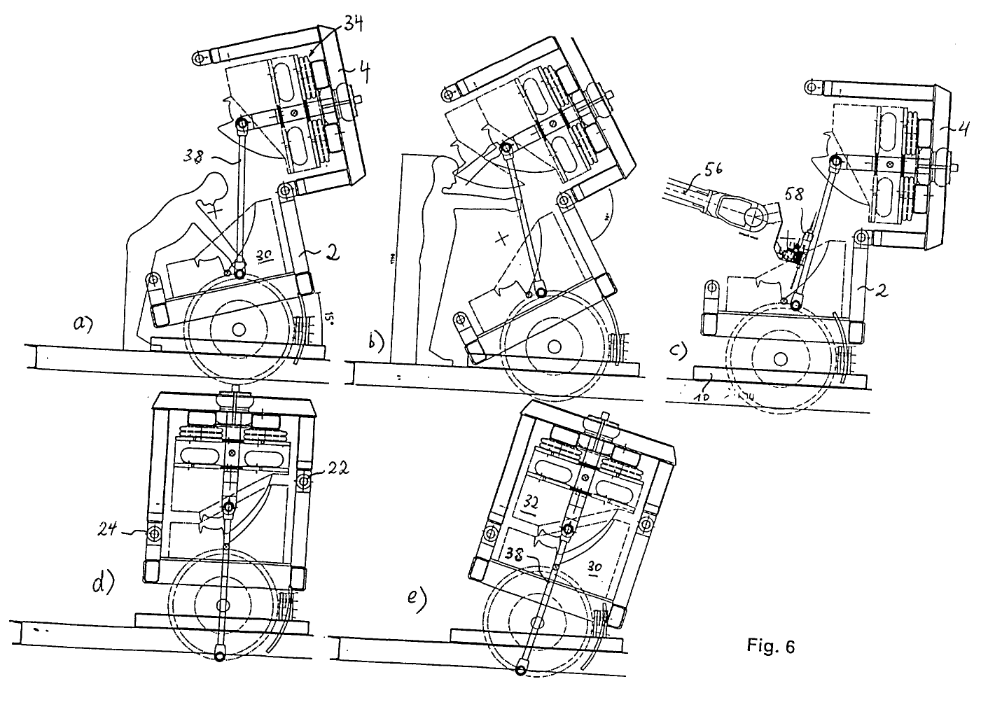

Turning now to FIGS. 6a-6e, there are shown schematic side views of a fifth embodiment of a closing unit according to the present invention in various operating positions during the production process. Parts corresponding with those in FIGS. 1 to 2 are denoted by identical reference numerals and not explained again. This embodiment differs from the embodiment of FIG. 1 by the arrangement of the crank drive at a central location between the upper mold carrier 4 and the lower mold carrier 2 which are configured substantially as described and shown in FIG. 1. The shifting device 34 is here provided, by way of example, in the upper mold carrier 4 to provide the parallel movement of the half-mold 32 for closing the cavity.

The production cycle of the closing unit of FIG. 6 is executed in substantially the same manner as described in conjunction with FIG. 2. In the fully opened position the crank arm 38 occupies the upper dead center position, as shown in FIG. 6a, while the lower dead center position is reached when the closing unit is fully closed, as shown in FIG. 6e.

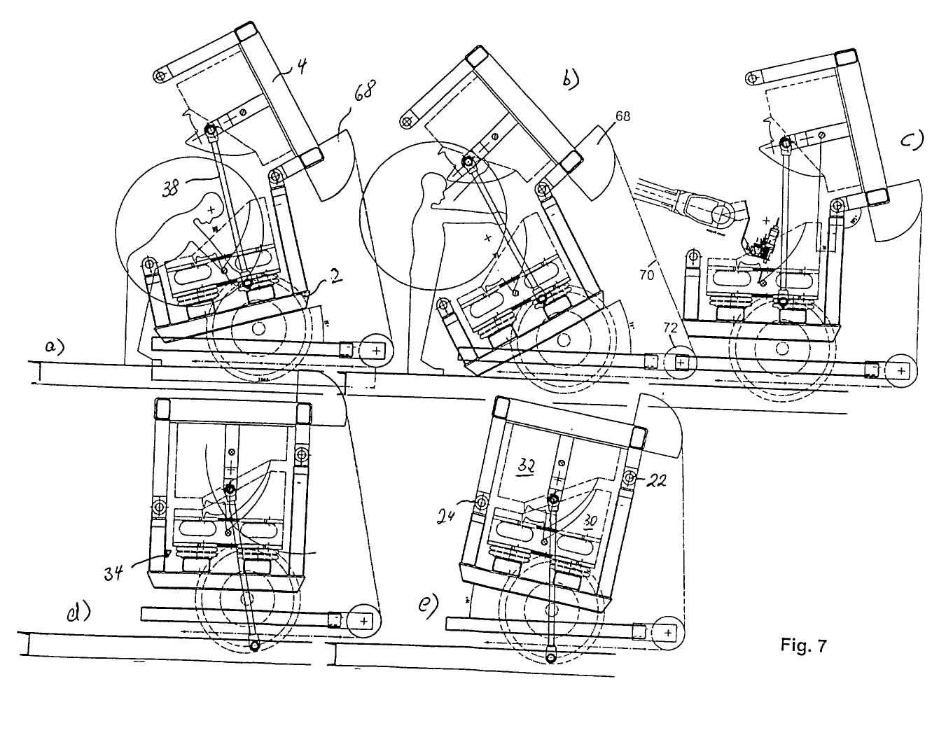

FIGS. 7a-7e show various operating positions during a production process of a sixth embodiment of a closing unit according to the present invention. Parts corresponding with those in FIGS. 1 to 2 are denoted by identical reference numerals and not explained again. This embodiment of the closing unit differs from the embodiment of FIG. 6 by the off-center disposition of the pivot axis of the crank arm 38 below the lower mold carrier 4 and the exemplified disposition of the shifting device 34 in the lower mold carrier 2. In addition, a counterweight 68 is mounted to the upper mold carrier 4 and a tension member 70 trained about pulleys 72 (only one is shown here for sake of simplicity) is provided to assist the motor (not shown) and to compensate movement moments. The production cycle of the closing unit of FIG. 7 is executed in substantially the same manner as described in conjunction with FIGS. 2 and 6.

The crank drive may be operated by an electromotor, although other drives such as hydraulic motors or pneumatic motors are conceivable as well. Persons skilled in the art will also understand that the crank arm does not have to be directly driven, which means that gears, transmissions or the like may be interposed.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A closing unit of a plastic molding machine, comprising:
a first mold mounting plate;
a second mold mounting plate; and
a crank drive for realizing a relative movement of the first and second mold mounting plate between an open position and a closed position.

2. The closing unit of claim 1, wherein the closed position is established, when the crank drive assumes a dead center position.

3. The closing unit of claim 2, wherein the open position is established, when the crank drive assumes another dead center position.

4. The closing unit of claim 1, wherein the crank drive is defined by a drive train composed of a driven crank arm and a lever which are hingedly connected together, said drive train having one end connected to one of the first and second mold mounting plates and another end operatively connected to the other one of the first and second mold mounting plates.

5. The closing unit of claim 4, and further comprising a support mounted on a machine bed, wherein the other end of the drive train is connected to the other one of the first and second mold mounting plates via the support.

6. The closing unit of claim 4, wherein the drive train is operatively connected to the one of the first and second mold mounting plates laterally of a pivot bearing.

7. The closing unit of claim 4, wherein the drive train is operatively connected to the one of the first and second mold mounting plates approximately at midpoint between two sides of the one mold mounting plate.

8. The closing unit of claim 1, and further comprising a pivot bearing for connecting the first and second mold mounting plates.

9. The closing unit of claim 1, and further comprising a locking mechanism for releasably securing the first and second mold mounting plates in the closed position.

10. The closing unit of claim 1, and further comprising locking bars for releasably securing the first and second mold mounting plates in the open position.

11. The closing unit of claim 1, and further comprising a machine bed, wherein one of the first and second mold mounting plates is swingably mounted to the machine bed.

12. The closing unit of claim 1, wherein one of the first and second mold mounting plates is lockable in at least one pivot position.

13. The closing unit of claim 1, and further comprising two releasable pivot bearings arranged on opposite sides of the first and second mold mounting plates.

14. The closing unit of claim 1, and further comprising a plurality of said crank drive.

15. The closing unit of claim 1, and further comprising a single motor for operating the plurality of said crank drive.

16. A reaction injection molding machine, comprising a closing unit having a first mold mounting plate, a second mold mounting plate, and a crank drive for realizing a relative movement of the first and second mold mounting plate between an open position and a closed position.

17. A closing unit for a plastic molding machine, comprising:
an upper mold mounting plate;
a lower mold mounting plate swingably mounted to the first mold mounting plate;
a crank drive acting on the upper mold mounting plate for moving the upper mold mounting plate relative to the lower mold mounting plate between open and closed positions;
a first locking mechanism for releasably securing the upper and lower mold mounting plates to one another, when the upper mold mounting plate is in the closed position; and
a second locking mechanism for releasably securing the lower mold mounting plate in at least one pivoted position.

18. The closing unit of claim 17, wherein the crank drive includes a crank arm which assumes a dead center position, when the upper mold mounting plate is in the closed position.

19. The closing unit of claim 17, wherein the crank drive includes a crank arm which assumes a first dead center position, when the upper mold mounting plate is in the closed position, and a second dead center position, when the an upper mold mounting plate is in the open position.

20. The closing unit of claim 17, wherein the crank drive includes a motor, a crank arm driven by the motor, and a lever having one end articulated to the crank arm and another end mounted to a fixed support.

21. The closing unit of claim 17, wherein the crank drive includes a motor, a crank arm driven by the motor and connected to the lower mold mounting plate, and a lever having one end articulated to the crank arm and another end mounted to the upper mold mounting plate.

22. The closing unit of claim 17, wherein the crank drive includes a motor, and a crank arm driven by the motor and extending between the lower mold mounting plate and the upper mold mounting plate.
